(19) United States
(12) Patent Application Publication
(10) Pub. No.: US 2024/0223052 A1
(43) Pub. Date: Jul. 4, 2024

(54) MANUFACTURING METHOD OF MAGNETIC ASSEMBLY WINDING

(71) Applicant: SEA SONIC ELECTRONICS CO., LTD., Taipei (TW)

(72) Inventors: Sheng-Chien CHOU, Taipei (TW); Chi-Hao CHANG, Taipei (TW)

(21) Appl. No.: 18/149,503

(22) Filed: Jan. 3, 2023

(51) Int. Cl. H02K 15/04

(52) U.S. Cl. CPC H02K 15/0442

(57) ABSTRACT

A manufacturing method of a magnetic assembly winding includes the following steps: providing a winding frame; and then winding a plurality of turns of basic coils on the winding frame with a wire, wherein lengths of two ends of the wire to a segment of the wire wound into the basic coils is longer than a length of the wire wound with a plurality of turns of coils; and then, continuing winding of the plurality of turns of coils by two wire segments of the wire connected with two ends of each basic coil to complete a magnetic assembly winding, respectively. The magnetic assembly winding comprises two tail segments; and the two tail segments are formed by extending outermost ones of the plurality of coils.

### FIELD OF THE INVENTION

The present invention relates to a manufacturing method of a magnetic assembly winding, in particular to a forming method in which two outlet terminals of the magnetic assembly winding are formed by extending outermost ones of a plurality of coils.

### BACKGROUND OF THE INVENTION

A winding is one of important components of a magnetic assembly. Apart from current solutions implemented by integrated circuits, the winding mainly has two implementation solutions: firstly, the winding is directly wound on a winding frame; and secondly, a component (wire cake) form participates in configuration of the magnetic assembly. In any of the above two implementation solutions, in winding of the winding, winding of the winding frame is started by a part of a wire near one terminal; after winding start, winding is continued only in a same direction; when a number of winding turns (i.e., a number of winding turns) reaches a set value, continuous winding is stopped; and after the part of the wire is cut off, two ends of the wire are used as two outlet terminals.

However, the current winding method makes one of the two outlet terminals come from an inner turn of the winding (as shown in 50 in FIG. 1), which leads to overlapping of the winding caused by adjustment of a position of an outlet part of the inner ring. A height of the above overlapping part is at least a wire diameter of the wire, which further affects power density of the magnetic assembly and is not in line with current research and development trends.

### SUMMARY OF THE INVENTION

The main purpose of the present invention is to solve consequent implementation problems caused by existing winding methods of magnetic assembly windings.

To achieve the above purpose, the present invention provides a manufacturing method of a magnetic assembly winding, comprising the following steps:
step 1: providing a winding frame;
step 2: winding a wire on the winding frame to form a plurality of turns of basic coils, wherein each length of two ends of the wire to a segment of the wire wound into the plurality of turns of basic coils is larger than a length of a segment of the wire wound into a plurality of turns of coils; and
step 3: continuing winding of the plurality of turns of coils by winding two wire segments of the wire connected with two ends of the plurality of turns of basic coils to complete a magnetic assembly winding, respectively, wherein the magnetic assembly winding comprises two tail segments formed by extending two outermost turns of the plurality of turns of coils.

In one embodiment, in step 3, one of the two wire segments is firstly wound into the plurality of turns of coils to form a first part; the other one of the two wire segments is subsequently wound into the plurality of turns of coils wound by the first part to form a second part and overlapped with the first part; and the two tail segments are formed by extending outermost segments of the first part and the second part respectively.

In one embodiment, in step 2, a segment of the wire not at the two ends of the wire is used as a winding start part; winding two segments of the wire adjacent to the winding start part to form the plurality of turns of basic coils; and numbers of turns of coils wound by the two segments of the wire are different.

In one embodiment, the manufacturing method further comprises step 4: performing a shaping operation on the magnetic assembly winding and removing the winding frame

In one embodiment, the wire comprises a metal inner core and a hot-meltable sheath covering the metal inner core.

In one embodiment, the shaping operation is performed by adhesive dispensing.

In one embodiment, the shaping operation is performed by winding of an adhesive tape.

Through the above implementation of the present invention, compared with the prior art, the present invention has the following characteristics: the basic coils initially generated by winding using the method of the present invention contribute to subsequent continuous winding of the coils, so that the whole winding step is simple. According to the present invention, through the above method, the wound magnetic assembly winding no longer overlaps with the parts of the coils due to adjustment of a position of an outlet part of an inner ring, so that power density of a magnetic assembly which applies the magnetic assembly winding is not affected.

### BRIEF DESCRIPTION OF THE DRAWINGS

FIG. 1 is a schematic structural diagram of a magnetic assembly winding in the prior art.

FIG. 2 is a schematic structural diagram of a magnetic assembly winding according to one embodiment of the present invention.

FIG. 3 is a schematic diagram of steps of a forming method of a magnetic assembly winding according to one embodiment of the present invention.

FIG. 4 is a first schematic diagram of implementation of a forming method of a magnetic assembly winding according to one embodiment of the present invention.

FIG. 5 is a second schematic diagram of implementation of a forming method of a magnetic assembly winding according to one embodiment of the present invention.

FIG. 6 is a third schematic diagram of implementation of a forming method of a magnetic assembly winding according to one embodiment of the present invention.

FIG. 7 is a schematic diagram of steps of a forming method of a magnetic assembly winding according to another embodiment of the present invention.

FIG. 8 is a schematic diagram of a cross-sectional structure of a wire used in a magnetic assembly winding according to one embodiment of the present invention.

FIG. 9 is a schematic structural diagram of a magnetic assembly winding according to another embodiment of the present invention.

FIG. 10 is a schematic structural diagram of a magnetic assembly winding according to further another embodiment of the present invention.

### DETAILED DESCRIPTION OF THE PREFERRED EMBODIMENTS

The detailed description and technical contents of the present invention are described as follows with reference to the drawings:

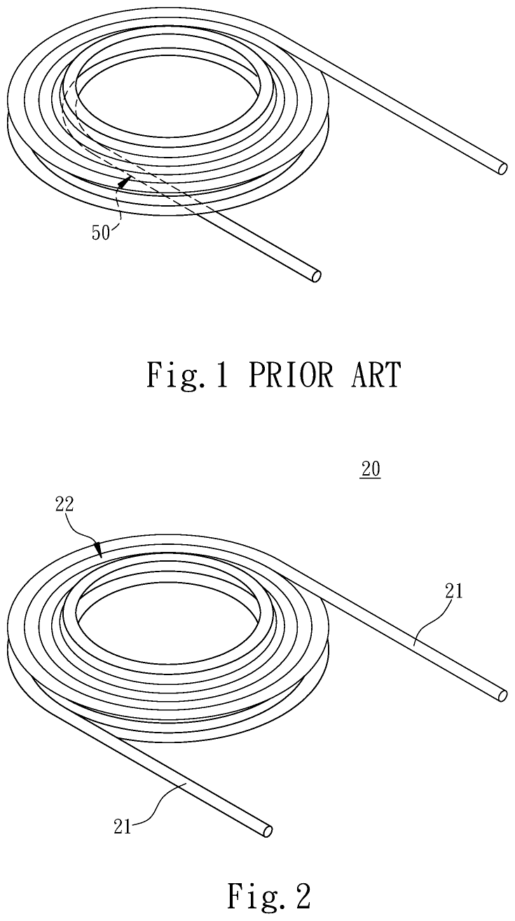

Referring to FIG. 2, the present invention provides a magnetic assembly winding 20 characterized in that: two tail segments 21 of the magnetic assembly winding 20 are formed by two outermost segments extending from a plurality of coils 22 included in the magnetic assembly winding 20. According to the present invention, the magnetic assembly winding 20 does not comprise a terminal directly extending from an inner turn of the magnetic assembly winding 20 so that the magnetic assembly winding 20 does not have the plurality of coils 22 to be overlapped because of adjustment of a position of the inner ring coiled out, and power density of a magnetic assembly applied to the magnetic assembly winding 20 is not affected. On the other hand, the magnetic assembly winding 20 of the present invention may be an independent component (as shown in FIG. 1, which is called a wire cake in the industry) used to configure a magnetic assembly; or the magnetic assembly winding 20 may be a winding generated in a winding process of a transformer.

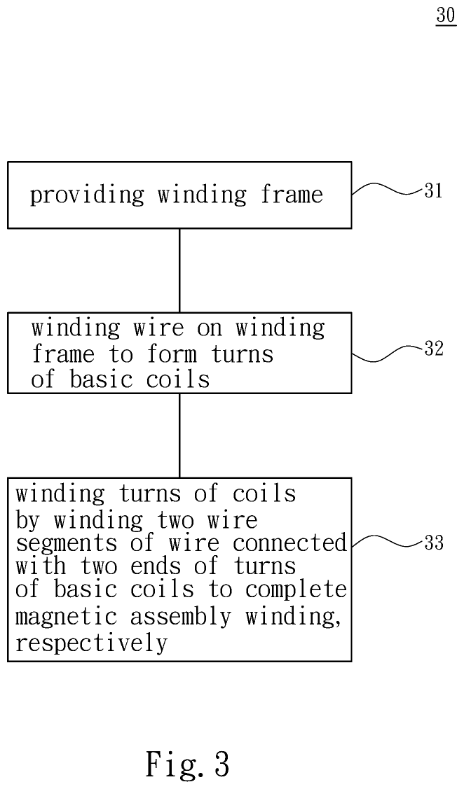

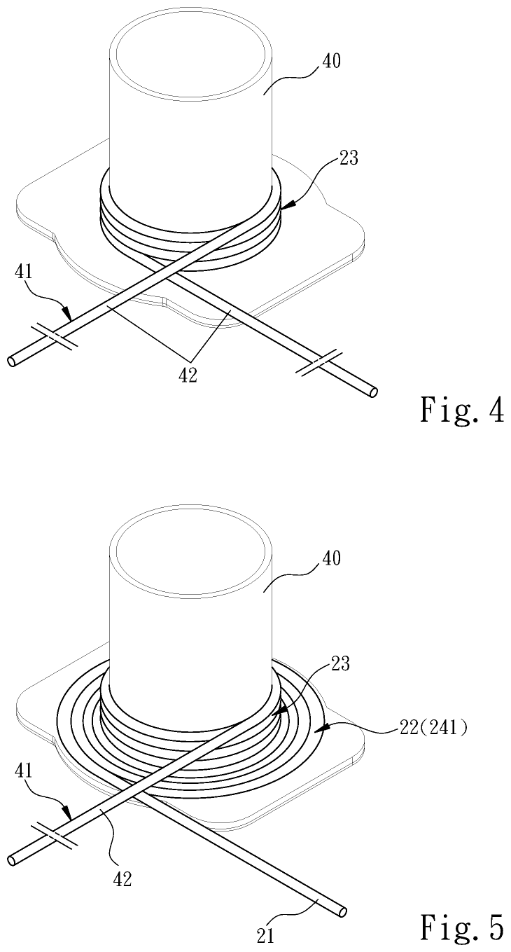

Referring to FIG. 2, FIG. 3 and FIG. 4, in order to manufacture the magnetic assembly winding 20, the present invention further provides a manufacturing method 30 of the magnetic assembly winding 20, which comprises the following steps:
step 1 (31): providing a winding frame 40;
step 2 (32): winding a wire 41 on the winding frame 40 to form a plurality of turns of basic coils 23, wherein each length of two ends of the wire 41 to a segment of the wire 41 wound into the plurality of turns of basic coils 23 is longer than a length of a segment of the wire 41 wound into a plurality of turns of coils 22; and
step 3 (33): continuing winding of the plurality of turns of coils 22 by two wire segments 42 of the wire 41 connected with two ends of the plurality of turns of basic coils 23 to complete a magnetic assembly winding 20, respectively, wherein the magnetic assembly winding 20 comprises two tail segments 21 formed by extending two outermost turns of the plurality of turns of coils 22.

Further, the winding frame 40 can be selected in a proper form according to implementation requirements. The winding frame 40 may be implemented as a transformer winding frame or may be separated after the magnetic assembly winding 20 is manufactured. On the other hand, the wire 41 may be an enameled wire, a multilayer insulated wire, etc.

Referring to FIG. 3 and FIG. 4, in step 2 (32), a segment of the wire 41 which is not at two ends is used as a winding start part. Further, the length of the wire segment of the wire 41 remained after start winding, which is not only used as one of the two tail segments 21, but can still be wound with a certain number of turns. In one embodiment, during the implementation of step 2 (32), winding two segments of the wire 41 adjacent to the winding start part to form the plurality of turns of basic coils 23, and numbers of turns of coils wound by the two segments of the wire 41 are different. For example, one of the two segments is wound by one turn, and the other one of the two segments is wound by two turns. Further, as mentioned above, the two segments are inseparable from the wire 41. The two segments remained after winding will continue the implementation of step 3 (33). In other words, after the wire 41 completes winding of the plurality of turns of basic coils 23, each length of two ends of the wire 41 to a segment of the wire 41 wound into the plurality of turns of basic coils 23 will be longer than the length of the wire 41 wound into the plurality of turns of coils 22; and lengths of the two ends of the wire 41 to a segment of the wire 41 wound into the plurality of turns of basic coils 23 are be equal to lengths of each of the two tail segments remained after winding. In addition, in the process of winding the plurality of turns of basic coils 23 by each of the two segments of the wire 41, at least one of the plurality of turns of basic coils 23 wound by one of the two segments of the wire 41 will be overlapped on at least one of the plurality of turns of basic coils 23 wound by the other one of the two segments of the wire 41 along the winding frame 40.

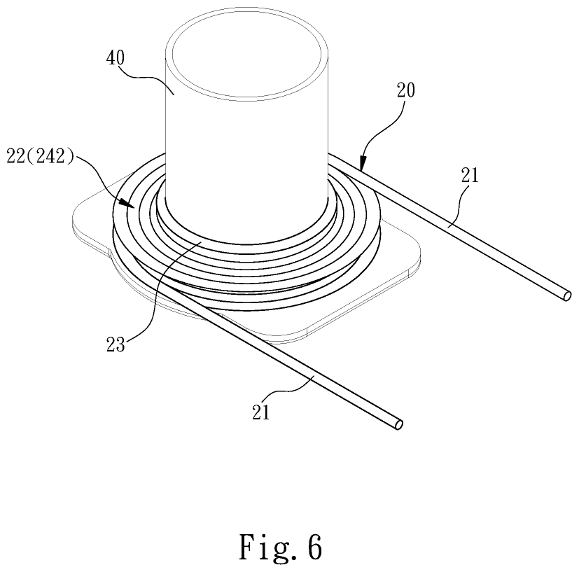

Referring to FIG. 3, FIG. 5 and FIG. 6, after step 2 (32) is completed, implementation of step 3 (33) is continued. The two wire segments 42 of the wire 41 connected with two ends of the plurality of turns of basic coils 23 (i.e. the two tail segments remained after winding as above mentioned) are used for winding the plurality of turns of coils 22, respectively. In the process of winding, connecting points of the two wire segments 42 and the plurality of turns of basic coils 23 are starting points for winding; a winding direction is not along the winding frame 40, but overlapping one turn on another. After winding in a predetermined number of turns is completed, the magnetic assembly winding 20 is finalized. The two tail segments 21 of the magnetic assembly winding 20 are formed by extending two outermost turns of the plurality of turns of coils 22 in view of the method of the present invention, thereby solving various problems caused by coiling-out of the inner turn. Further, the predetermined number of turns does not refer to a total number of turns of the magnetic assembly winding 20. The total number of turns of the magnetic assembly winding 20 is the number of turns of the basic coils 23 plus the number of turns of the coils 22. In one embodiment, in step 3 (33), one of the two wire segments 42 is firstly wound into the plurality of turns of coils 22 to form a first part 241, the other one of the two wire segments 42 is subsequently wound into the plurality of turns of coils 22 by adopting the first part 241 as a base to form a second part 242 overlapping the first part 241, and the two tail segments 21 are formed by extending outermost turns of the first part 241 and the second part 242 respectively.

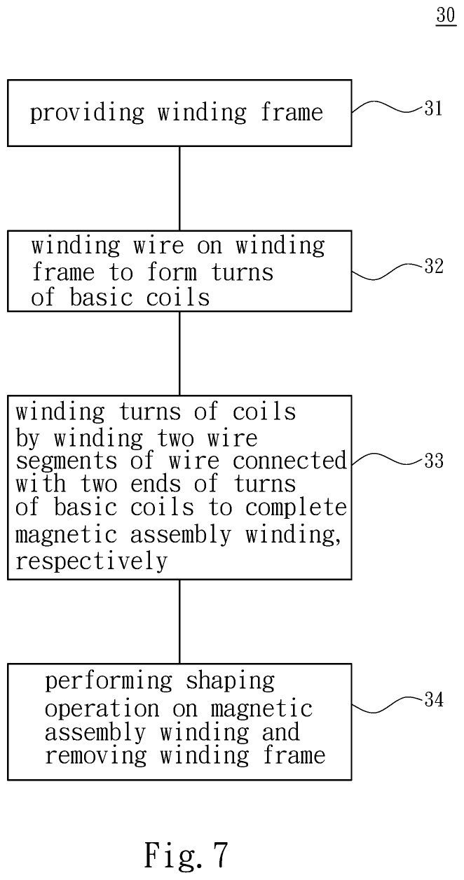

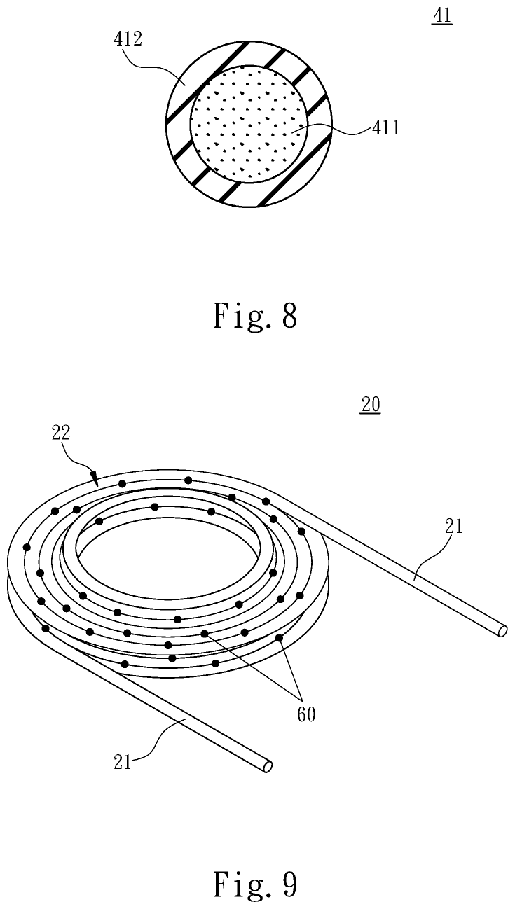

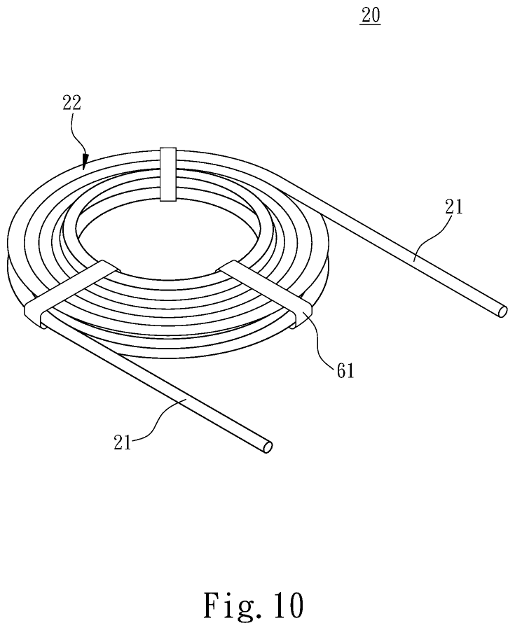

Referring to FIG. 7, in one embodiment, the forming method 30 of the magnetic assembly winding further comprises step 4 (34): performing a shaping operation on the magnetic assembly winding 20 and removing the winding frame 40. After step 4 (34) of the present embodiment is performed, the magnetic assembly winding 20 can be used in subsequent magnetic assembly configuration in the form of a component. Referring to FIG. 8, in one embodiment, the wire 41 comprises a metal inner core 411 and a hot-meltable sheath 412 covering the metal inner core 411. The shaping operation is performed by heating a semi-finished product of the magnetic assembly winding 20, so that the hot-meltable sheath 412 is hot-melted; and after cooling, completing shaping. In addition to the foregoing, the setting operation may also be performed by adhesive dispensing or winding of an adhesive tape; and a dispensing location can be selected according to implementation requirements. Adhesive dispersing can be disclosed as shown in FIG. 9, wherein the mark number 60 in FIG. 9 is the dispensing location. A solution of winding of the adhesive tape can be shown in FIG. 10, wherein the mark number 61 in FIG. 10 is the adhesive tape.

What is claimed is:

1. A manufacturing method of a magnetic assembly winding, comprising the following steps:
step 1: providing a winding frame;
step 2: winding a wire on the winding frame to form a plurality of turns of basic coils, wherein each length of two ends of the wire to a segment of the wire wound into the plurality of turns of basic coils is larger than a length of a segment of the wire wound into a plurality of turns of coils; and
step 3: continuing winding of the plurality of turns of coils by winding two wire segments of the wire connected with two ends of the plurality of turns of basic coils to complete a magnetic assembly winding, respectively, wherein the magnetic assembly winding comprises two tail segments formed by extending two outermost turns of the plurality of turns of coils.

2. The manufacturing method of the magnetic assembly winding according to claim 1, wherein in step 3, one of the two wire segments is firstly wound into the plurality of turns of coils to form a first part; the other one of the two wire segments is subsequently wound into the plurality of turns of coils wound by the first part to form a second part and overlapped with the first part; and the two tail segments are formed by extending outermost segments of the first part and the second part respectively.

3. The manufacturing method of the magnetic assembly winding according to claim 2, wherein in step 2, a segment of the wire not at the two ends of the wire is used as a winding start part; winding two segments of the wire adjacent to the winding start part to form the plurality of turns of basic coils; and numbers of turns of coils wound by the two segments of the wire are different.

4. The manufacturing method of the magnetic assembly winding according to claim 1, wherein in step 2, a segment of the wire not at two ends of the wire is used as a winding start part; winding two segments of the wire adjacent to the winding start part to form the plurality of turns of basic coils; and numbers of turns of coils wound by the two segments of the wire are different.

5. The manufacturing method of the magnetic assembly winding according to claim 1, further comprising step 4: performing a shaping operation on the magnetic assembly winding and removing the winding frame.

6. The manufacturing method of the magnetic assembly winding according to claim 5, wherein the wire comprises a metal inner core and a hot-meltable sheath covering the metal inner core.

7. The manufacturing method of the magnetic assembly winding according to claim 5, wherein the shaping operation is performed by adhesive dispensing.

8. The manufacturing method of the magnetic assembly winding according to claim 5, wherein the shaping operation is performed by winding of an adhesive tape.

9. The manufacturing method of the magnetic assembly winding according to claim 2, further comprising step 4: performing a shaping operation on the magnetic assembly winding and removing the winding frame.

10. The manufacturing method of the magnetic assembly winding according to claim 9, wherein the wire comprises a metal inner core and a hot-meltable sheath covering the metal inner core.

11. The manufacturing method of the magnetic assembly winding according to claim 9, wherein the shaping operation is performed by adhesive dispensing.

12. The manufacturing method of the magnetic assembly winding according to claim 9, wherein the shaping operation is performed by winding of an adhesive tape.

13. The manufacturing method of the magnetic assembly winding according to claim 4, further comprising step 4: performing a shaping operation on the magnetic assembly winding and removing the winding frame.

14. The manufacturing method of the magnetic assembly winding according to claim 13, wherein the wire comprises a metal inner core and a hot-meltable sheath covering the metal inner core.

15. The manufacturing method of the magnetic assembly winding according to claim 13, wherein the shaping operation is performed by adhesive dispensing.

16. The manufacturing method of the magnetic assembly winding according to claim 13, wherein the shaping operation is performed by winding of an adhesive tape.
